(19) United States
(12) Patent Application Publication
(10) Pub. No.: US 2026/0104568 A1
(43) Pub. Date: Apr. 16, 2026

(54) LENS MOUNT, LASER DEVICE, METHOD FOR PRODUCING A MONOLITHIC LENS MOUNT, AND METHOD FOR PRODUCING A LENS MOUNT

(71) Applicant: JENOPTIK Optical Systems GmbH, Jena (DE)

(72) Inventors: Marco BORNSCHEIN, Jena (DE); Frank SCHROEDER, Jena (DE); Matthias BENING, Jena (DE); Stephan FAHR, Jena (DE)

(73) Assignee: JENOPTIK Optical Systems GmbH, Jena (DE)

(21) Appl. No.: 19/115,767

(22) PCT Filed: Aug. 10, 2023
(86) PCT No.: PCT/EP2023/072142

§ 371 Date: Mar. 26, 2025

(30) Foreign Application Priority Data
Sep. 26, 2022 (DE) 10 2022 124 609.4

(51) Int. Cl. G02B 7/02; G02B 19/00

(52) U.S. Cl. CPC G02B 7/02; G02B 19/0009; G02B 19/0047

(57) ABSTRACT

A lens mount (100) comprises an outer ring (105), an inner ring (110) and at least one connecting piece (115). The inner ring (110) is designed to accommodate a lens. The outer ring (105) and the inner ring (110) are connected to one another via the at least one connecting piece (115). The connecting piece (115) forms a first portion having a first length, a second portion having a second length and an intermediate portion having an intermediate length. The intermediate portion is arranged between the first portion and the second portion. The first portion is connected to the inner ring (110). The second portion is connected to the outer ring (105). In this case, a shape of a cross section of the intermediate portion in an intermediate sectional plane differs from a shape of a first cross section of the first portion in a first sectional plane and from a shape of a second cross section of the second portion in a second sectional plane.

### PRIOR ART

The invention proceeds from a lens mount, a laser device, a method for producing a monolithic lens mount and a method for producing a lens mount according to the preamble of the independent claims.

DE 10 2015 115 929 B3 describes a monolithic lens mount.

Given this background, the approach presented here presents an improved lens mount, an improved laser device, an improved method for producing a monolithic lens mount and an improved method for producing a lens mount in accordance with the main claims. Advantageous further developments and improvements of the device indicated in the independent claim are possible by means of the measures presented in the dependent claims.

The lens mount can advantageously enable reliable accommodation of a lens, wherein the lens can be held by the lens mount in a manner decoupled from stress.

The lens mount presented has an outer ring, an inner ring and at least one connecting web. The inner ring is designed to accommodate a lens. The outer ring and the inner ring are connected to one another via the at least one connecting web. The connecting web forms a first portion having a first length, a second portion having a second length and an intermediate portion having an intermediate length. The intermediate portion is arranged between the first portion and the second portion. The first portion is connected to the inner ring. The second portion is connected to the outer ring. In this case, a shape of a cross section of the intermediate portion in an intermediate sectional plane differs from a shape of a first cross section of the first portion in a first sectional plane and from a shape of a second cross section of the second portion in a second sectional plane.

The lens mount can, for example, be used for a device for semiconductor inspection and be designed to accommodate a lens. A lens can be understood to mean an optical element that transmits in at least one range. The lens can have a refractive power or can be designed as a wedge or a flat plate. The lens may but does not have to have reflective regions. The lens may but does not have to have absorbing regions. The lens may be provided as an imaging lens or as part of an imaging objective, for example. The lens may also be a projection lens or part of a projection objective. The lens may form an optical element for directing or shaping a beam, e.g. laser beam. For direction and shaping, use may also be made of an objective or a telescope, and therefore several lenses may be employed. When several lenses are used, a dedicated lens mount can be provided for each of the lenses. In principle, other light sources are also possible instead of a laser. The inner ring of the lens mount can have elastic elements for accommodating the lens to enable the lens to be held reliably in the inner ring. The connecting web can be arranged between the inner ring and the outer ring of the lens mount. Via the outer ring, the lens mount can be attached to an objective housing, for example. The connecting web enables mechanical decoupling of the inner ring from the outer ring, thus enabling the lens to be held by the inner ring in a manner that is stable relative to the surroundings. The connecting web can be formed as a bent beam. The sectional planes chosen can be perpendicular to a beam longitudinal direction. In the case of the bent beam, the beam longitudinal direction can be interpreted as a tangent to a beam center line. According to bending beam theory, the beam center line, which can also be referred to as the beam axis, can represent the neutral axis when the beam is bent. The beam center line can advantageously lie on a circle around an axis of the lens mount, e.g. a centrally extending longitudinal axis. The sectional plane can then be defined by the radial direction and the longitudinal axis. The longitudinal axis can correspond to the optical axis of the lens to be accommodated. The cross sections of the first portion and of the second portion can be shaped as rectangles. The cross section of the intermediate portion can likewise be shaped as a rectangle, but can have edge lengths and/or dimensions different from the cross sections of the first portion and the second portion, or can be shaped as a trough, for example.

The lens mount can form a stress-decoupled monolithic mount for optical components. The lens mount can be employed for telescopes, objectives or optical systems, for example. To be more precise, the main area of application for the lens mount is for mounting optical components with a high stress birefringence specification. In this case, the use of at least three connecting webs for mechanically decoupling an optical lens mounted in the inner ring from deformation of the outer ring on account of radial and/or axial force distribution acting on the outer ring, in particular nonuniform radial and/or axial force distribution, is particularly preferred. It is thereby possible to minimize unwanted stress birefringence of the light in the lens.

With the approach presented here, a small installation space for the connecting web can be achieved in the radial direction, thereby enabling a larger lens to be mounted with the same outside diameter of the mount. Another advantage is that the manufacturing effort and thus also costs for the lens mount can be kept low.

The lens mount can be formed monolithically. In this case, the lens mount can have an annular body which is subdivided by material recesses into the outer ring, the inner ring and the at least one connecting web. Thus, the lens mount can advantageously be produced in a simple and low-cost manner.

The lens mount can have at least three, in particular precisely three, connecting webs, which are each arranged offset by an offset angle with respect to one another and via which the inner ring is connected to the outer ring. The connecting webs can be formed in the same way and can enable stable connection between the inner ring and the outer ring. The use of at least three connecting webs can enable mechanical decoupling of an optical lens mounted in the inner ring from deformation of the outer ring on account of radial and/or axial force distribution acting on the outer ring.

An embodiment with a rigid inner ring is particularly preferred. The outer ring can also be of rigid design, while the connecting webs can be elastically deformable and can act as solid-body joints.

In a radial direction with respect to an axis of the lens mount, the cross section of the intermediate portion can have the same extent as the first cross section of the first portion, and, in addition or as an alternative, the cross section of the intermediate portion can have a taper relative to the first cross section of the first portion in an axial direction with respect to the axis of the lens mount. It is thus advantageously possible to achieve a good decoupling property.

The first cross section of the first portion can have a greater axial than radial extent with respect to the axis of the lens mount, and, in addition or as an alternative, the cross section of the intermediate portion can have a smaller axial than radial extent with respect to the axis of the lens mount. In this case, the cross section of the intermediate portion can have a smaller axial extent than the first and/or second portion. The radial extent can be very thin, thus enabling a very thin extent to be achieved radially and/or axially. It is thus advantageously possible to keep a required installation space small.

The cross section of the intermediate portion can have a smaller cross-sectional area than the first cross section of the first portion and, in addition or as an alternative, than the second cross section of the second portion. It is thus advantageously possible to save installation space.

The first cross section and the second cross section can be formed in such a way as to be the same. In addition or as an alternative, the first length and the second length can be the same. This facilitates production.

The intermediate portion can be made shorter than the first portion and shorter than the second portion. It is thereby advantageously possible to achieve a good damping property with respect to transmission of stresses or deformations via the connecting web.

The first portion and, in addition or as an alternative, the intermediate portion and, in addition or as an alternative, the second portion can be formed tangentially in a manner free from a radial component. This facilitates production.

At least in the region of the intermediate sectional plane, the intermediate portion can have a cutout. The cutout can be aligned in the axial direction or in the radial direction. The cutout can have any desired shape, e.g. can have a round cross section. The cutout can be implemented as a through-hole or a blind hole. By means of the cutout, it is possible to reduce the transmission of deformations and stresses via the connecting web.

The cutout can be formed as a drill hole, milled hole or eroded hole, for example. The cutout can thus be formed quickly and reliably.

In the region of the intermediate sectional plane, the connecting web can have a taper, which influences a bending stiffness of the connecting web. The connecting web can thus advantageously decouple deformations of the lens.

A first side of the intermediate portion can have at least one first cutout and, in addition or as an alternative, a second side of the intermediate portion can have at least one second cutout. In this case, the first cutout and the second cutout can be arranged opposite or offset with respect to one another. In addition, the cutouts can be of the same size or alternatively have a different size. Depending on the formation and arrangement of the cutouts, different decoupling properties can be achieved.

As an advantageous possibility, precisely two cutouts per connecting web can be embodied as opposite blind holes, or precisely one cutout can be embodied as a blind hole, wherein these can advantageously be made in the axial direction. If two blind holes per connecting web are provided, these can advantageously be coaxial with one another.

The connecting web can be formed as a bending beam. Such a bending beam is, on the one hand, stable enough to enable a secure connection between the inner ring and the outer ring and, on the other hand, flexible enough to enable mechanical decoupling between the inner ring and the outer ring.

According to one embodiment, the connecting web can have, apart from at least one cutout in the intermediate portion, a flat surface extending over the intermediate portion as well as the first portion and the second portion.

A laser device for emitting a laser beam can have an embodiment of a lens mount mentioned herein and a lens, accommodated by the lens mount, for directing the laser beam. The laser device can be used for semiconductor inspection, for example. By means of such an embodiment too, the advantages of the approach described here can be achieved in a very efficient way.

A method for producing a monolithic lens mount comprises a step of supply, a step of production, a step of tangential slotting and a step of further tangential slotting. In the step of supply, a blank having an inner receiving portion for an optical element, in particular for a lens, and an outer mount portion, are supplied, wherein the blank has an axis. In the step of production, a plurality of recesses, at least three recesses, arranged symmetrically with respect to the axis and so as to run toward one another on one side or both sides, is produced. In the step of tangential slotting, the blank is slotted with a slot subdivided into a plurality of sectors on an outer radius. In the step of further tangential slotting, the blank is slotted with a slot subdivided into the multi-part sectors on an inner radius. In this case, the recesses are arranged between the inner and the outer radius within the sectors. By means of such an embodiment too, the advantages of the approach described here can be achieved in a very efficient way.

As a preferred option, elastic elements designed as solid bodies can be attached to the inner ring, in particular contours in the form of leaf springs provided with an additional bending beam function. In particular, these additional bending beams can be extended with a beam length in the axial direction, a beam width in the tangential direction and a small beam height in the radial direction in comparison with the beam width. These additional bending beams can thus deflect resiliently in the radial direction at the free end. The lens can rest against the free ends of the additional bending beams. In this way, diameter tolerances of the lens can be compensated without the lens being subject to excessive mechanical stress. A respective fixed end can be situated opposite the free ends of the additional bending beams and can be arranged on the inner ring.

A method for producing one embodiment of a lens mount mentioned herein comprises a step of supply of a monolithic blank, a step of forming at least one cutout in a surface of the blank, and a step of slotting the blank in order to form the outer ring, the inner ring and the at least one connecting web. In this case, the cutout is arranged in the region of the intermediate portion of the connecting web. By means of such an embodiment too, the advantages of the approach described here can be achieved in a very efficient way. If the cutout is formed before the slotting of the blank, the high stability of the blank can be exploited to enable the cutout to be formed with high accuracy. In the step of slotting, a plurality of slots can be formed, e.g. by means of a punching operation or laser cutting.

According to one embodiment, production by 3D printing or by sintering can be made possible, the accuracy of which can be improved to an increasing extent. At least one combination of 3D printing or sintering with subsequent mechanical machining, e.g. by means of erosion or laser machining, can offer one production variant.

Exemplary embodiments of the approach presented here are illustrated in the drawings and explained in greater detail in the following description. In the drawings:

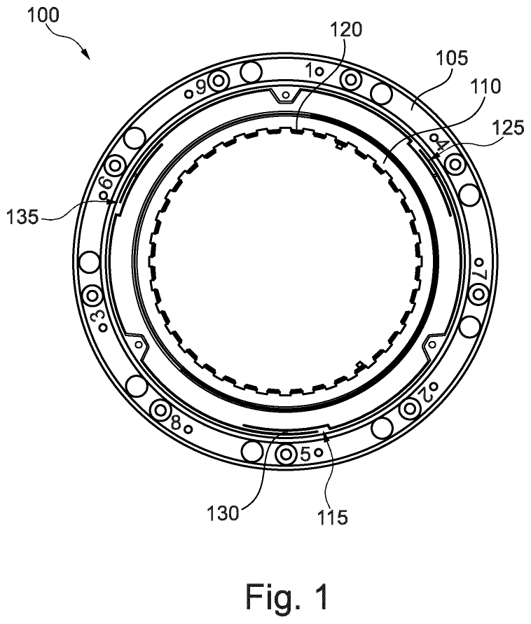

FIG. 1 shows a plan view of one exemplary embodiment of a lens mount;

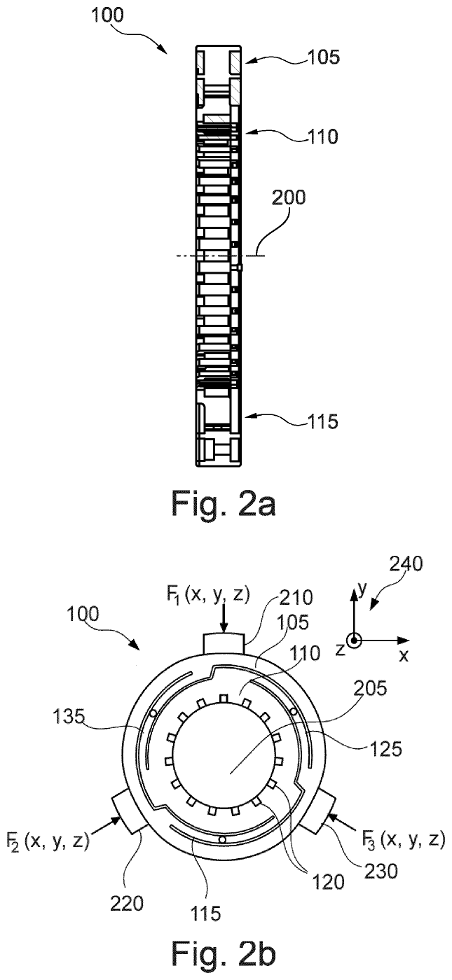

FIG. 2a shows a sectioned side view of one exemplary embodiment of a lens mount;

FIG. 2b shows a plan view of one exemplary embodiment of a lens mount;

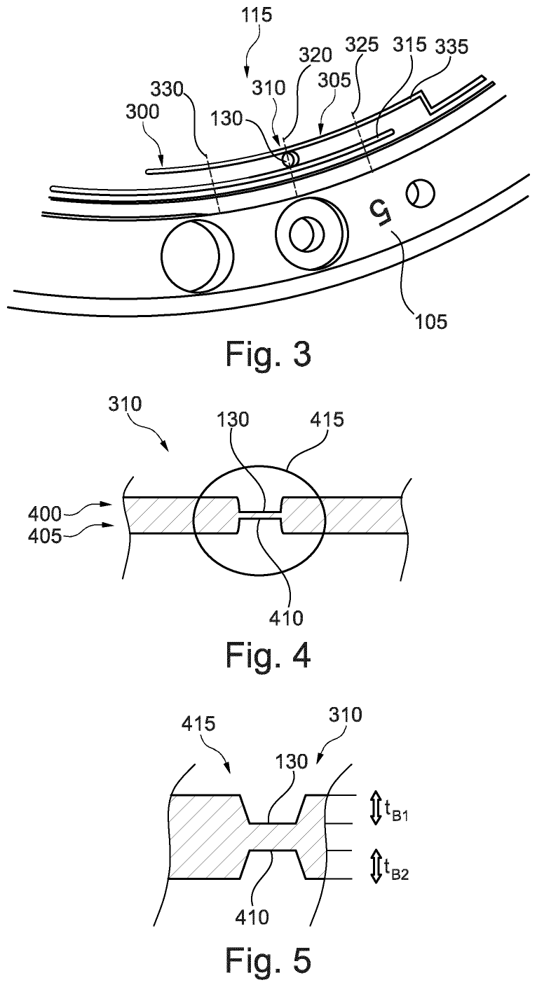

FIG. 3 shows a plan view of a connecting web for one exemplary embodiment of a segment of a lens mount;

FIG. 4 shows a schematic sectioned side view of an intermediate portion for one exemplary embodiment of a lens mount;

FIG. 5 shows a schematic sectioned side view of an intermediate portion for one exemplary embodiment of a lens mount;

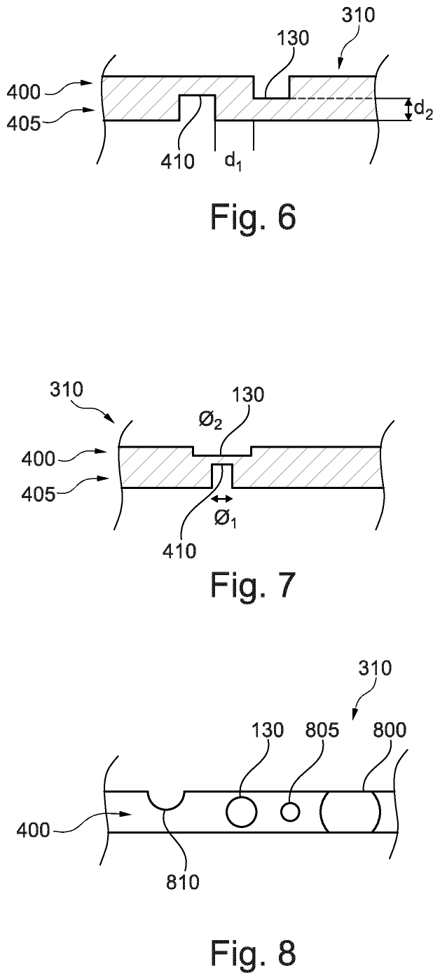

FIG. 6 shows a schematic sectioned side view of an intermediate portion for one exemplary embodiment of a lens mount;

FIG. 7 shows a schematic sectioned side view of an intermediate portion for one exemplary embodiment of a lens mount;

FIG. 8 shows a schematic sectioned plan view of an intermediate portion for one exemplary embodiment of a lens mount;

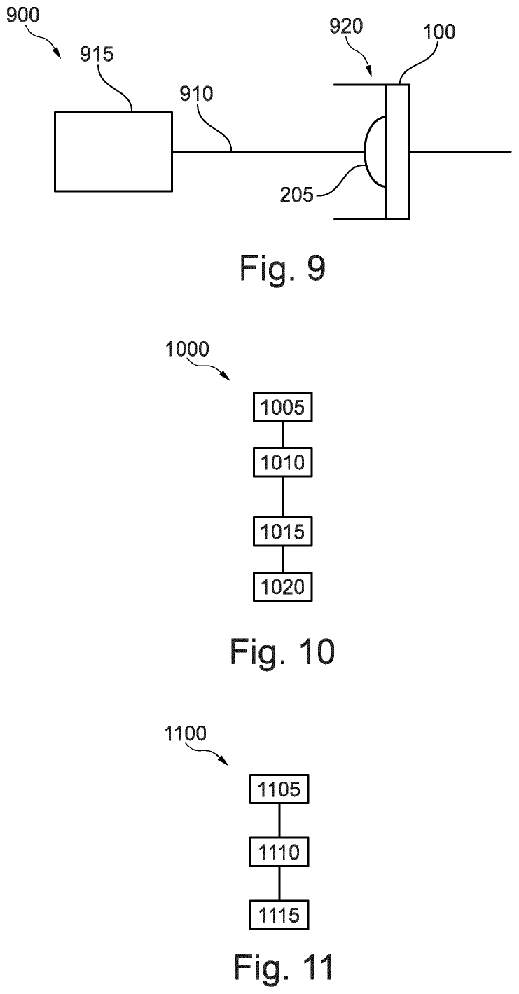

FIG. 9 shows a schematic illustration of a side view of one exemplary embodiment of a laser device;

FIG. 10 shows a flow diagram of one exemplary embodiment of a method for producing a monolithic lens mount; and

FIG. 11 shows a flow diagram of one exemplary embodiment of a method for producing a lens mount.

In the following description of advantageous exemplary embodiments of the present invention, the same or similar reference signs are used for the elements with a similar action which are illustrated in the various figures, with repeated description of these elements being omitted.

If an exemplary embodiment includes an “and/or” conjunction between a first feature and a second feature, this should be interpreted to mean that, according to one embodiment, the exemplary embodiment has both the first feature and the second feature and, according to another embodiment, has either only the first feature or only the second feature.

FIG. 1 shows a plan view of one exemplary embodiment of a lens mount 100. The lens mount 100 is designed to accommodate a lens. The lens mount 100 can be used in an objective or a telescope, for example. For example, the lens mount 100 can be used for a device for semiconductor inspection.

In principle, the lens mount 100 serves for the mechanical retention of at least one optical single-lens element or of cemented assemblies. For lens systems subject to high requirements on imaging quality, it is furthermore significant that the lenses are mounted in a stable manner with respect to the surroundings and, at the same time, as far as possible without deformation and without stress. Among the measures to achieve this, use is made of at least one decoupling structure, which is arranged between an inner and an outer mount part.

Accordingly, the lens mount 100 illustrated here has an outer ring 105, an inner ring 110 and, as a decoupling structure, at least one connecting web 115. The connecting web 115 is arranged between the inner ring 110 and the outer ring 105, and therefore the outer ring 105 and the inner ring 110 are connected to one another via the connecting web 115. The inner ring 110 is designed to accommodate a lens. For this purpose, the inner ring 110 forms, for example, a plurality of elastic elements 120 in order to reliably accommodate the lens.

According to one exemplary embodiment, elastic elements 120 designed as solid bodies are attached to the inner ring 110, in particular having contours in the form of leaf springs provided with an additional bending beam function. In particular, the elastic elements 120 are designed as bending beams and accordingly can also be referred to as bending beams. The elastic elements 120 are extended with a beam length in the axial direction, a beam width in the tangential direction and a small beam height in the radial direction in comparison with the beam width. The elastic elements 120 can thus deflect resiliently in the radial direction at the free end. The lens can rest against the free ends of the elastic elements 120. In this way, diameter tolerances of the lens and differences in expansion in the case of temperature fluctuations can be compensated without the lens being subject to excessive mechanical stress. A respective fixed end can be situated opposite the free ends of the elastic elements 120 and can be arranged on the inner ring 110.

According to the exemplary embodiment illustrated here, the lens mount 100 has a plurality of connecting webs, in this case, by way of example a total of three connecting webs 115, 125, 135, which are arranged offset with respect to one another. In this case, by way of example, the connecting webs 115, 125, 135 all have the same shape.

According to one exemplary embodiment, the lens mount 100 is formed monolithically. In other words, the lens mount 100 represents a monolithic connection between the outer ring 105, which can also be referred to as an outer mount part, and the inner ring 110, which can also be referred to as an inner mount part, via at least the one connecting web 115, which can also be referred to as a radial bending beam. According to one exemplary embodiment, this connecting web 115 is characterized in that the connecting web 115 has at least one cutout 130 in order to decouple additional deformations. As an option, the connecting web 115 has a corresponding cutout 130 symmetrically on both sides.

The advantage of this solution is that the radial installation space is small and thus, in contrast to alternative solutions involving a larger installation space requirement, a larger lens can be mounted with the same outside diameter of the mount. Another advantage is that the manufacturing effort and thus also costs for this solution are lower.

FIG. 2a shows a sectioned side view of one exemplary embodiment of a lens mount 100. Here, the lens mount 100 resembles or corresponds to the lens mount from FIG. 1.

The outer ring 105, the inner ring 110 and the connecting web 115 are illustrated in section by way of example. An axis 200 is illustrated by way of example. In this case, the axis 200 runs centrally through the lens mount 100 and thus represents a longitudinal axis. The axis 200 runs through a central point of the inner ring and of the outer ring of the lens mount 100.

FIG. 2b shows a plan view of one exemplary embodiment of a lens mount 100. Here, the lens mount 100 resembles or corresponds to the lens mount from FIG. 1.

According to one exemplary embodiment, the lens mount 100 has a lens 205, which is accommodated by the inner ring 110. By way of example, three force components 210, 220, 230 are arranged on an outer surface of the outer ring 105, each being distributed around the outer ring 105 at an angle of 120 degrees for example. Here, the first force component represents a first force F1, the second force component 220 represents a second force F2, and the third force component represents a third force F3. In this case, by way of example, the force components 210, 220, 230 are arranged on the outer ring 105 in such a way that, for example, the first force component 210 is arranged between the third connecting web 135 and the second connecting web 125, the second force component 220 is arranged between the connecting web 115 and the third connecting web 135, and the third force component 230 is arranged between the second connecting web 125 and the first connecting web 115.

The forces F1, F2, F3 are designed, for example, to act on the outer ring 105 and thus bring about a deformation of the outer ring 105 (the deformation was indicated in FIG. 2b by the non-circularity of the outer contour of the outer ring 105).

By way of example, FIG. 2b shows a clamping situation of the lens mount 100 in a chuck of a lathe with the introduction of the three forces F1, F2 and F3 with the respective force components Fx, Fy, Fz.

Thus, FIG. 2b schematically indicates an asymmetric action of forces via the outer ring 105. Here, F1, F2 and F3 are forces which, as illustrated here, are introduced via a clamping device, a chuck, of a lathe. In this case, the forces are composed of the respective x, y, and z direction components Fx, Fy, and Fz. An x-y-z axis 240 is illustrated by way of example. The forces are introduced at very different angles, depending on the preloading situation in the chuck. The forces F1, F2, F3 lead at least to an elastic change in shape in the region of the force introduction zones. According to the invention, to ensure that the resulting stresses do not affect the overall lens mount 100 and stresses are transmitted to the lens 205, stress decoupling from the inner ring 110 takes place by means of the connecting webs 115, 125, 135 and the elastic elements 120.

Thus, forces, in this case by way of example the forces F1, F2, F3, the overall effect of which does not result in any acceleration or any torque but in deformation of the outer ring, can be absorbed.

FIG. 3 shows a plan view of a connecting web 115 for one exemplary embodiment of a segment of a lens mount. In this case, the connecting web 115 resembles or corresponds to the connecting web from one of the preceding figures.

The connecting web 115 is formed as a bending beam, for example. Furthermore, the connecting web 115 forms a first portion 300, a second portion 305 and an intermediate portion 310. In this case, the intermediate portion 310 is arranged between the first portion 300 and the second portion 305. The first portion 300 and the second portion 305 have the same shape and length, for example. In this case, the first portion 300 is connected to the inner ring, and the second portion 305 is connected to the outer ring 105.

According to one exemplary embodiment, the intermediate portion 310 has a different shape from that of portions 300 and 305, at least in the region of an intermediate sectional plane 320. For example, a shape of a cross section of the intermediate portion 310 in the intermediate sectional plane 320 differs from a shape of a first cross section of the first portion 300 in a first sectional plane 330 and from a shape of a second cross section of the second portion 305 in a second sectional plane 325.

According to one exemplary embodiment, the intermediate portion 310 has, at least at the level of the intermediate sectional plane 320, a cutout 130, which gives rise to a shape of the intermediate portion 310 which is different from portions 300 and 305. The cutout 130 is embodied as a blind hole, for example, and, by way of example, is formed as a drill hole, milled hole or eroded hole.

Along its direction of longitudinal extent, the connecting web 115 has a curvature which follows a circular arc around the longitudinal axis of the lens mount. For example, the connecting web 115 extends over a center angle with respect to the longitudinal axis of more than 10° and less than 60°.

By way of example, the connecting web 115 has a length which corresponds to at least 5 times the width of the connecting web 115 and/or a length which corresponds to less than 20 times the width of the connecting web 115. According to one exemplary embodiment, the connecting web 115 is formed by two slots 315, 335. In this case, a first slot 335 runs along an inner edge of the connecting web 115 and separates the connecting web 115 from the inner ring 110, apart from an inner region of connection to the inner ring 110. A second slot 315 runs along an outer edge of the connecting web 115 and separates the connecting web 115 from the outer ring 105, apart from an outer region of connection to the outer ring 105. The inner region of connection runs radially with respect to the longitudinal axis, and the outer region of connection runs along a circular arc around the longitudinal axis. Along the edges of the connecting web 115, the slots 315, 335 run along circles around the longitudinal axis of the lens mount.

According to one exemplary embodiment, the connecting web 115 has a flat surface over its entire length on the upper side shown in FIG. 3, apart from the at least one cutout 130. As an option, the connecting web 115 has a flat surface over its entire length on an underside opposite the upper side shown in FIG. 3, apart from at least one optional additional cutout. According to one exemplary embodiment, the surfaces of the connecting web 115 merge seamlessly into corresponding surfaces of the outer ring 105 and of the inner ring 115 in the regions of connection on the upper side and the underside.

FIG. 4 shows a schematic sectioned side view of an intermediate portion 310 along a longitudinal extent of a connecting web for one exemplary embodiment of a lens mount. Here, the intermediate portion 310 resembles or corresponds to the intermediate portion from FIG. 4.

The intermediate portion 310 has a first side 400 and a second side 405. The cutout 130 is formed in the essentially flat surface of the first side 400, and a second cutout 410 is formed in the essentially flat surface of the second side 405. According to the exemplary embodiment shown here, the cutouts 130, 410 are arranged directly opposite one another and, by way of example, have the same diameter. On account of the cutouts 130, 410, the connecting web has a taper.

A detail 415 of the intermediate portion 310 is illustrated on an enlarged scale in FIG. 5.

FIG. 5 shows a schematic sectioned side view of an intermediate portion 310 for one exemplary embodiment of a lens mount. To be more precise, FIG. 5 shows the detail 415 of the intermediate portion 310 illustrated in FIG. 4. Purely by way of example, the cutouts 130, 410 are drillings. Here, t_{B1} represents a depth of the drilling of the cutout 130 and t_{B2} represents a depth of the drilling of the second cutout 410. According to the exemplary embodiment shown here, t_{B1} is less than t_{B2}. As an alternative, t_{B1} and t_{B2} are equal or t_{B1} is greater than t_{B2} or t_{B1} is equal to zero or t_{B2} is equal to zero. The latter cases correspond to a blind hole on one side, which is not illustrated here.

FIG. 6 shows a schematic sectioned side view of an intermediate portion 310 along a longitudinal extent of a connecting web for one exemplary embodiment of a lens mount. Here, the intermediate portion 310 resembles or corresponds to the intermediate portion from FIG. 4, with the exception that the cutouts 130, 410 are arranged offset with respect to one another along the longitudinal axis.

d₁ represents an offset between the cutouts 130, 410 along the longitudinal extent of the connecting web. d₂ represents a remaining thickness of the connecting web in the region of the second cutout 410. Here, the thickness d₁ corresponds to the thickness d₂ or d₁ is greater than d₂ or d₁ is less than d₂. The number of cutouts 130, 410 can be chosen in a suitable manner, wherein the number of cutouts N_{B} is greater than or equal to 1.

FIG. 7 shows a schematic sectioned side view along a longitudinal extent of a connecting web of an intermediate portion 310 for one exemplary embodiment of a lens mount. According to the exemplary embodiment shown here, the cutouts 130, 410 are arranged directly opposite one another and have a different size. To be more precise, the cutouts 130, 410 have a different diameter. Here, Ø₂ represents a diameter of the first cutout 130 and Ø₁ represents a further diameter of the second cutout 410. According to the exemplary embodiment shown here, Ø₁ is less than Ø₂. Alternatively, Ø₁ greater than Ø₂ or Ø₁ corresponds to Ø₂.

Furthermore, by way of example, the second cutout 410 is deeper than cutout 130.

FIG. 8 shows a schematic plan view of an intermediate portion 310 for one exemplary embodiment of a lens mount. According to the exemplary embodiment shown here, the intermediate portion 310 has a plurality of cutouts.

The plan view shows the first side 400 of the connecting web, for example. Here, the cutout 130 corresponds to the cutout shown in FIG. 3, for example. The other cutouts 800, 805, 810 are formed differently from cutout 130. To be more precise, the cutouts 130,, 800, 805, 810 have different positions and diameters. In this case, cutout 800 has a larger diameter than cutout 130 and cutout 805. Cutout 805 has a smaller diameter than the other cutouts 130, 800, for example. Cutout 810 is semicircular, while cutouts 130, 800, 805 are circular.

According to one exemplary embodiment, cutout 810 extends right through a connecting web edge connecting the first side 400 and the opposite second side. In this case, the cutout 810 forms a slot extending over the edge.

FIG. 9 shows a schematic illustration of a side view of one exemplary embodiment of a laser device 900. In this case, the laser device 900 has a laser 915 and a lens mount 100, wherein the lens mount 100 resembles or corresponds to the lens mount from the figures described above. The laser device 900 furthermore has a lens 205. The lens 205 is accommodated by the inner ring of the lens mount 100 and designed to direct, e.g. focus, a laser beam 910. The lens mount 100, together with the lens 205, is part of an objective 920. The lens mount 100 is connected to a housing of the objective 920 via the outer ring, for example.

The laser device 900 can be used for semiconductor inspection, for example. In this case, the lens mount 100 is used, for example, if an optical component is subject to demanding requirements in respect of accuracy or stress birefringence and external deformations are to be kept away from the optical component.

FIG. 10 shows a flow diagram of one exemplary embodiment of a method 1000 for producing a monolithic lens mount. The method 1000 comprises a step 1005 of supply, a step 1010 of production, a step 1015 of tangential slotting and a step 1020 of further tangential slotting. In the step 1005 of supply, a blank having an inner receiving portion for an optical element, in particular for a lens, and an outer mount portion, are supplied, wherein the blank has an axis. In the step 1010 of production, a plurality of cutouts, at least three recesses, arranged symmetrically with respect to the axis and so as to run toward one another on one side or both sides, is produced. In the step 1015 of tangential slotting, the blank is slotted with a slot subdivided into a plurality of sectors on an outer radius. In the step 1020 of further tangential slotting, the blank is slotted with a slot subdivided into the multi-part sectors on an inner radius. In this case, the recesses are arranged between the inner and the outer radius within the sectors.

FIG. 11 shows a flow diagram of one exemplary embodiment of another method 1100 for producing a lens mount. Here, the lens mount resembles or corresponds to the lens mount from one of the figures described herein.

The method 1100 comprises a step 1105 of supply of a monolithic blank, a step 1110 of forming at least one cutout in a surface of the blank, and a step 1115 of slotting the blank. In the step 1110 of forming, one or more cutouts are formed in a surface or, for example, in two mutually opposite surfaces of the blank, more specifically at positions which are in a region envisaged for an intermediate portion of a connecting web. By means of the step 1115 of slotting, slots that pass completely through the blank are produced, by means of which the at least one connecting web is cut free, as shown, for example, in FIG. 2. The step of producing 1010 the recesses takes place, for example, before the step of tangential slotting 1015 and before the step of further tangential slotting 1020.

1. A lens mount comprising:
an outer ring;
an inner ring, which is designed to accommodate a lens; and
at least one connecting web, via which the outer ring and the inner ring are connected to one another,
wherein the connecting web forms a first portion having a first length, a second portion having a second length, and an intermediate portion having an intermediate length,
wherein the intermediate portion is arranged between the first portion and the second portion,
wherein the first portion is connected to the inner ring and the second portion is connected to the outer ring, and
wherein a shape of a cross section of the intermediate portion in an intermediate sectional plane differs from a shape of a first cross section of the first portion in a first sectional plane and from a shape of a second cross section of the second portion in a second sectional plane.

2. The lens mount as claimed in claim 1, wherein the lens mount is formed monolithically and wherein the lens mount has an annular body which is subdivided by material recesses into the outer ring, the inner ring and the at least one connecting web.

3. The lens mount as claimed in claim 1, wherein the lens mount has at least three, in particular precisely three, connecting webs, which are each arranged offset by an offset angle with respect to one another and via which the inner ring is connected to the outer ring.

4. The lens mount as claimed in claim 1, wherein, in a radial direction with respect to an axis of the lens mount, the cross section of the intermediate portion has the same extent as the first cross section of the first portion, and/or wherein the cross section of the intermediate portion has a taper relative to the first cross section of the first portion in an axial direction with respect to the axis of the lens mount.

5. The lens mount as claimed in claim 1, wherein the first cross section of the first portion has a greater axial than radial extent with respect to the axis of the lens mount, and/or wherein the cross section of the intermediate portion has a smaller axial than radial extent with respect to the axis of the lens mount, and/or wherein the cross section of the intermediate portion has a smaller cross-sectional area than the first cross section of the first portion (300) and/or than the second cross section of the second portion.

6. The lens mount as claimed in claim 1, wherein the first cross section and the second cross section are formed in such a way as to be the same, and/or wherein the first length and the second length are the same, and/or wherein the intermediate portion is shorter than the first portion and/or shorter than the second portion.

7. The lens mount as claimed in claim 1, wherein the first portion and/or the intermediate portion and/or the second portion are formed tangentially in a manner free from a radial component.

8. The lens mount as claimed in claim 1, wherein, at least in a region of the intermediate sectional plane, the intermediate portion has at least one, in particular precisely one or precisely two, cutout(s), in particular wherein the cutout is formed as a drill hole, milled hole or eroded hole, in particular as a blind hole.

9. The lens mount as claimed in claim 1, wherein, in the region of the intermediate sectional plane, the connecting web has a taper, which influences a bending stiffness of the connecting web.

10. The lens mount as claimed in claim 1, wherein a first side of the intermediate portion has at least one first cutout, and/or a second side of the intermediate portion has at least one second cutout, wherein the first cutout and the second cutout are arranged opposite or offset with respect to one another and/or have a different size.

11. The lens mount as claimed in claim 1, wherein the connecting web is formed as a bending beam which, apart from at least one cutout has a flat surface.

12. A laser device for emitting a laser beam, the laser device comprising:
a lens mount as claimed in claim 1; and
a lens, accommodated by the lens mount, for directing the laser beam.

13. A method for producing a monolithic lens mount, the method comprising:
supplying a blank having an inner receiving portion for an optical element, in particular for a lens, and an outer mount portion, wherein the blank has an axis;
producing a plurality of recesses, at least three recesses of the plurality of recesses being arranged symmetrically with respect to the axis and so as to run toward one another on one side or both sides;
tangential slotting the blank with a slot subdivided into a plurality of sectors on an outer radius; and
tangential slotting the blank with a slot subdivided into the plurality of sectors on an inner radius,
wherein the recesses are arranged between the inner and the outer radius within the sectors, and
wherein the step of producing the recesses takes place before the step of tangential slotting and before the step of further tangential slotting.

14. A method for producing a lens mount as claimed in claim 1, the method comprising:
supplying of a monolithic blank;
forming at least one cutout in a surface of the blank; and
slotting the blank in order to form the outer ring, the inner ring and the at least one connecting web,
wherein the cutout is arranged in the region of the intermediate portion of the connecting web.

15. A method, via use of at least three connecting webs for mechanically decoupling an optical lens mounted in an inner ring from deformation of an outer ring on account of radial and/or axial force distribution acting on the outer ring, in particular nonuniform radial and/or axial force distribution, the method comprising:
connecting the outer ring and the inner ring to one another via the connecting webs, wherein the connecting webs each form a first portion having a first length, a second portion having a second length and an intermediate portion having an intermediate length;
arranging the intermediate portion between the first portion (300) and the second portion;
connecting the first portion to the inner ring; and
connecting the second portion to the outer ring;
wherein a shape of a cross section of the intermediate portion in an intermediate sectional plane differs from a shape of a first cross section of the first portion in a first sectional plane and from a shape of a second cross section of the second portion in a second sectional plane.
